(19) United States
(12) Patent Application Publication
(10) Pub. No.: US 2014/0156410 A1
(43) Pub. Date: Jun. 5, 2014

(54) SYSTEMS AND METHODS TO PROVIDE TRANSPORT AWARE GEOFENCES

(71) Applicants: Markus Wuersch, Charlestown, MA (US); Sumit Shah, Waltham, MA (US)

(72) Inventors: Markus Wuersch, Charlestown, MA (US); Sumit Shah, Waltham, MA (US)

(73) Assignee: eBay Inc., San Jose, CA (US)

(21) Appl. No.: 13/691,390

(22) Filed: Nov. 30, 2012

(51) Int. Cl. G06Q 30/02

(52) U.S. Cl. CPC G06Q 30/0261
USPC 705/14.58

(57) ABSTRACT

Systems and methods for delivering transport aware publications to users in a network-based environment are discussed. In an example, a method for delivering transport aware advertisements can include receiving user-related location data, determining if a user is inside a transport time defined geofence, generating an advertisement, transmitting the advertisement, and optionally updating the advertisement. The transport time defined geofence may be specified by an advertiser to be directed to a set of users who are capable of traveling to a point of interest, such as a retail location, in the specified time period. The advertisement may be updated and include a dynamic content portion of the advertisement, and at least the updated dynamic content portion may be transmitted to the user. The advertisement is generated based at least in part on the user-related location data and transport data.

### TECHNICAL FIELD

This application relates generally to data processing within a network-based system operating over a distributed network, and more specifically to systems and methods to establish transport aware geographic regions (geo-fences) for dynamic publications or advertisements.

### BACKGROUND

The ever increasing use of smart phones, such as the iPhone® (from Apple, Inc. of Cupertino Calif.), with data connections and location determination capabilities is slowly changing the way people shop for products and services, find restaurants and entertainment events, and receive data. Smart phones can provide users with mobile access to the Internet that is quickly becoming fast and ubiquitous. Smart phones also commonly include mechanisms, such as Global Positioning System (“GPS”) receivers, that allow the devices to receive and constantly update location information.

Accordingly, the availability of portable implementations of locating technologies via mobile GPS capabilities and network assisted GPS in modem mobile devices (e.g., cellular telephones) is rapidly being commonplace. Furthermore, in many cases of Internet usage, a user's location can be established to varying degrees of confidence by other means such as Internet Protocol (“IP”) to location lookup. In addition, other location or location-related information may be known about a given user, such as home or office location, based on a user profile in the case of a logged-in user, or from Internet service provider (“ISP”) records. The end result is a rich set of data related to locations for any given Internet user and Internet usage session.

### BRIEF DESCRIPTION OF THE DRAWINGS

Some embodiments are illustrated by way of example and not limitation in the figures of the accompanying drawings in which:

FIG. 1 is a block diagram depicting a system for delivering transport aware advertisements, according to an example embodiment.

FIG. 2 is a block diagram illustrating an environment for operating a mobile device, according to an example embodiment.

FIG. 3 is a block diagram illustrating a mobile device, according to an example embodiment.

FIG. 4 is a block diagram illustrating a network-based system for delivering transport aware advertisements, according to an example embodiment.

FIG. 5 is a block diagram illustrating advertisement modules, according to an example embodiment.

FIG. 6 is a flowchart illustrating a method for delivering transport aware advertisements, according to an example embodiment.

FIG. 7 is a flowchart illustrating a method for receiving transport aware dynamic advertisements, according to an example embodiment.

FIG. 8 is a swim-lane chart illustrating a method for providing transport-aware offers, according to an example embodiment.

FIG. 9A is an example map illustrating a point of interest and various geofences, according to an example embodiment.

FIG. 9B is an example map illustrating a point of interest and various geofences, according to an example embodiment.

FIG. 10 is a diagrammatic representation of a machine in the example form of a computer system within which a set of instructions for causing the machine to perform any one or more of the methodologies discussed herein may be executed.

FIG. 11A-11C are diagrams illustrating an example transport aware dynamic advertisements, according to various example embodiments.

### DEFINITIONS

Location—For the purposes of this specification and the associated claims the term “location” is used to refer to a geographic location, such as a longitude/latitude combination, a postal code, an area code, or a street address. The term “location” is also used within this specification in reference to a physical location associated with a user, a retail outlet (e.g., store, theater, restaurant, etc.), or other similar physical locations.

Transport—For the purposes of this specification and the associated claims the term “transport” is used to refer to various manners in which a user (e.g., an individual person) may travel from a first location to a second location. The term “transport” is also used within this specification in reference to a distance or time, or both, to travel from a first location to a second location by one or more transport modes. Transport modes may include any mode of travel a user may utilize, including, but not limited to, walking, running, bicycling, or any mechanized mode of travel such as a car, bus, train, boat, airplane or the like.

Real-time—For the purposes of this specification and the associated claims the term “real-time” is used to refer to calculations or operations performed on-the-fly as events occur or input is received by the operable system. However, the use of the term “real-time” is not intended to preclude operations that cause some latency between input and response, so long as the latency is an unintended consequence induced by the performance characteristics of the machine. Further, introducing artificial delays between input and response should not cause the functionality to be outside the scope of real-time, unless the delay serves a particular purpose.

Geofence—For the purposes of this specification and the associated claims the term “geofence” is used to refer to various regions or boundaries of interest that include a geographic area within a distance or travel time to a point of interest. However, a geofence need not be limited to any geometric shape or an arbitrary boundary drawn on a map. A geofence can be used to determine a geographical area of interest for calculation of demographics, advertising, or similar purposes. Geofences can be used in conjunction with the advertisement generation and delivery concepts discussed herein. For example, a geofence can be used to assist in determining whether a user (or mobile device associated with the user) is within a geographic area of interest to a particular advertiser (e.g., a local merchant) or capable of traveling to the particular advertiser in a specified period of time. If the user is within a geofence established by the merchant, the systems discussed herein can use that information to generate a dynamic advertisement from the advertiser and deliver the offer to the user (e.g., via a mobile device associated with the user).

Additional detail regarding providing and receiving location-based services, including geo-location and geofence concepts, can be found in U.S. Pat. No. 7,848,765, titled “Location-Based Services,” granted to Phillips et al., which is hereby incorporated by reference.

### DETAILED DESCRIPTION

Example systems and methods for generating, delivering, and updating transport aware dynamic advertisements are described. The systems and methods for generating, delivering, and updating context sensitive dynamic advertisements, in some example embodiments, may provide advertisers the ability to target customers based on current location and calculated transport time to a point of interest of a user interacting with a network-based publication system. In the following description, for purposes of explanation, numerous specific details are set forth in order to provide a thorough understanding of example embodiments. It will be evident, however, to one skilled in the art that the present inventive subject matter may be practiced without these specific details. It will also be evident, that an offer publication system for generating, delivering, and updating context sensitive dynamic advertisements is not limited to the examples provided and may include other scenarios not specifically discussed.

In an example embodiment, methods and systems are provided to define a geofence including one or more users that are within a transport range of a point of interest. The transport range from the point of interest may be determined for individual users based on criteria including, but not limited to, a user's location, a distance from the user's location to the point of interest, available routes from the user's location to the point of interest, traffic conditions along the available routes, expected travel time along any of the available routes, and modes of transport that may be available to the user. The point of interest may include an outlet for an advertiser who wishes to send advertisements to the one or more users that are in the geofence. The advertisements may be delivered to the one or more user's device (e.g., PC, laptop, smart phone, mobile phone, etc.) over a network connection in response to the user's device providing location information that is within the geofence.

In accordance with an example embodiment, a network-based system can provide a platform to generate and deliver transport aware dynamic advertisements. In certain examples, a context is used to target, generate, and update the dynamic advertisements. The context can include a device's location and travel time between a device and an advertiser's location. In some examples, the user interacts with a network-based system via a personal computer or a mobile device, such as a smart phone, a tablet computing device, a notebook computer, or an Internet enabled personal digital assistant (PDA), among others. In an example, the network-based system can include a publication module capable of generating, delivering, and updating context sensitive dynamic advertisements.

In an example scenario, the network-based publication system can generate dynamic advertisements that include location related information that is updated in real-time as a user moves around. In this example, the user can interact with the network-based publication system via a mobile device that includes location determination capabilities. During interaction with the network-based publication system, the mobile device can continuously update the user's location. In turn, the network-based publication system can generate, deliver, and update advertisements from advertisers that are within a specified travel time from the advertiser's location that include location information or other contextual information that may or may not be location related. For example, the network-based publication system can generate an advertisement targeted to users that are within a specified travel time to an outlet for the particular advertiser. The transport related travel time information can be dynamically updated to account for movement by the mobile device, available routes to the outlet, or traffic conditions.

In another example scenario, the network-based publication system can combine location and transport data associated with the user to produce a dynamic advertisement that contains up-to-date information relevant to the user's current location and the amount of time needed for the user to travel to a location associated with the dynamic advertisement. For example, the owner of a local theater could use the network-based publication system to publish an advertisement that is directed only to users who can travel to the local theater within a fixed period of time, for example ten minutes. The advertisement may be directed to users that have indicated they have one or more modes of travel available to them. For example, the advertisement may be direct to a first user who is on foot and is at a location within a half-mile of the local theater, a second user who is three miles from the location theater and also within fifty yards of a public transportation route that is near the local theater, and to a third user who has a personal automobile within five miles of the local theater. Three logical geofences of varying sizes are logically illustrated in this example, one for each mode of transport based on a single predetermined or target transport time.

In another example, the network-based publication system can access local inventory for a marketplace, such as eBay Motors (from eBay, Inc. of San Jose, Calif.) and can display relevant listings based on a user's current location. In this example, the advertisement can include bid information and distance to the item (e.g., based on zip code or physical address). Advertisement targeting can be performed based on any internal or external data that can be used to define a reason to target a user.

The following table list examples of transport time factors (Table 1). The following table is only presented as examples and is not meant to present an exhaustive list:

TABLE 1
Transport Time Factors

Point of Interest (POI) location
User location
Distance (based on user location)
Travel Time
User Location
Weather Conditions
Traffic Delays
Accident Alerts
Public Transportation Routes
Pedestrian walkways
Available Travel Modes

### Example System

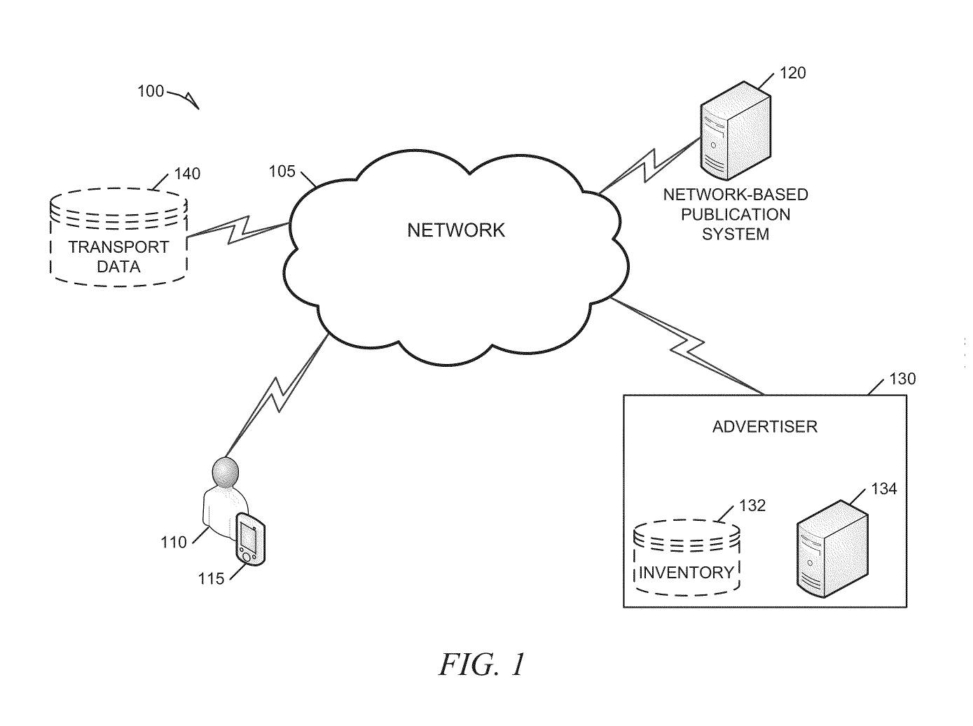

FIG. 1 is a block diagram depicting a system 100 for generating, delivering, and updating transport aware dynamic advertisements, over a network 105 according to an example embodiment. The system 100 can include a user 110, a network-based publication system 120, an advertiser 130, and optionally one or more external sources of transportation data, represented by transport data 140. In an example, the user 110 can connect to the network-based publication system 120 via a device 115 (e.g., smart phone, PDA, laptop, tablet, personal computer or similar electronic device capable of some form of data connectivity). In an example, the advertiser 130 can operate computer systems, such as an inventory system 132 or a merchandizing system 134. The network-based publication system 120 can interact with any of the systems used by the advertiser 130 for operation of the advertiser's retail or service business.

In an example, the network-based publication system 120 can work with both merchandizing system 134 and inventory system 132 to obtain access to inventory available at individual retail locations run by the merchant (e.g., context information). For example, the advertiser 130 can create rule-based instructions for use by the network-based publication system 120 in generating advertisements based on available inventory and that include dynamic inventory information. In an example, the advertiser 130 can access the network-based publication system 120 via a web interface to create rule-based instructions for use in generating advertisements.

In an example, the network-based publication system 120 can work with any of the systems used by the advertiser 130 and the transport data 140 to provide publications (e.g., advertisements) that are delivered to user 110 via the device 115 when the user 110 is at a location where the user 110 is able to reach a point of interest, such as a retail outlet associated with the advertiser 130, within a period of time specified by the advertiser 130. For example, the advertiser 130 may wish to publish advertisements that include content specifying a discounted price on an item or service if the user 110 can travel to the point of interest within a specified period of time via one or more transport modes. The network-based publication system 120 may receive location data from the device 115 associated with user 110, and determine based on transport data 140 whether or not the user 110 can travel to the point of interest within the specified period of time. If the user 110 is within a geographic area where travel to the point of interest is possible in the specified period of time, then the advertisement is sent to the user 110.

### Example Operating Environment

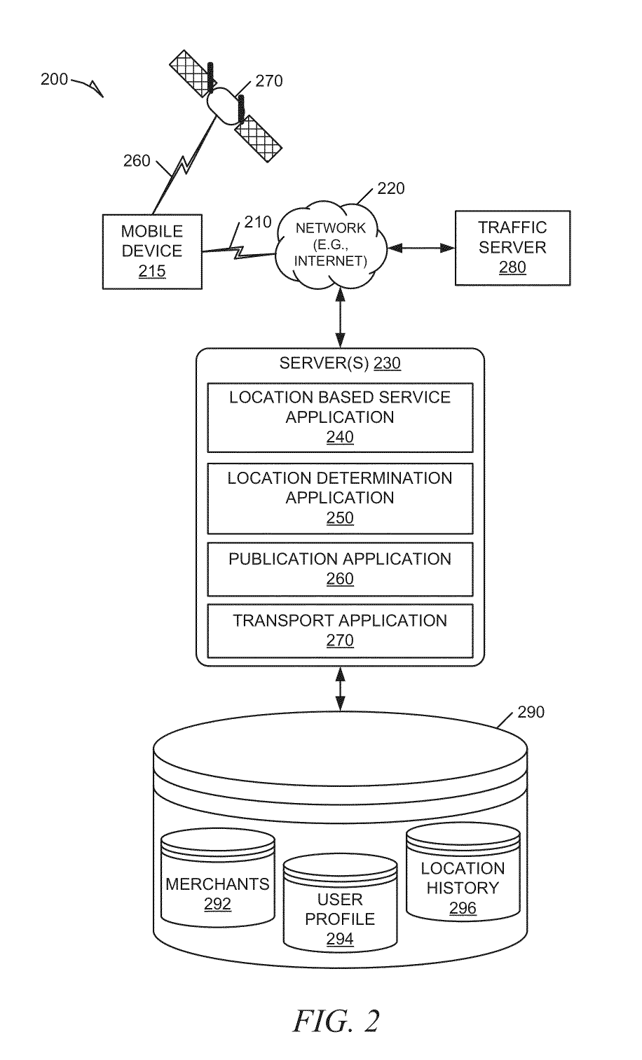

FIG. 2 is a block diagram illustrating an environment 200 for operating a mobile device 215, according to an example embodiment. The environment 200 is an example environment within which methods of generating, delivering, and updating transport aware advertisements can be performed. The mobile device 215 represents one example device that can be utilized by a user to receive advertisements and share location information with a network-based publication system, such as network-based publication system 120. The mobile device 215 may be any of a variety of types of devices, for example a cellular telephone, a smart phone, a personal digital assistant (PDA), a personal navigation device (PND), a handheld computer, a tablet computer, a notebook computer, or other type of movable device. The mobile device 215 may interface via a connection 210 with a communication network 220. Depending on the form of the mobile device 215, any of a variety of types of connections 210 and communication networks 220 may be used.

For example, the connection 210 may be Code Division Multiple Access (CDMA) connection, a Global System for Mobile communications (GSM) connection, or other type of cellular connection. Such connection 210 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 220 may include a cellular network that has a plurality of cell sites of overlapping geographic coverage, interconnected by cellular telephone exchanges. These cellular telephone exchanges may be coupled to a network backbone, for example, the public switched telephone network (PSTN), a packet-switched data network, or to other types of networks.

In another example, the connection 210 may be Wireless Fidelity (Wi-Fi, IEEE 802.11x type) connection, a Worldwide Interoperability for Microwave Access (WiMAX) connection, or another type of wireless data connection. In such an embodiment, the communication network 220 may include one or more wireless access points coupled to a local area network (LAN), a wide area network (WAN), the Internet, or other packet-switched data network. In yet another example, the connection 210 may be a wired connection, for example an Ethernet link, and the communication network 220 may be a local area network (LAN), a wide area network (WAN), the Internet, or other packet-switched data network. Accordingly, a variety of different configurations are expressly contemplated.

A plurality of servers 230 may be coupled via interfaces to the communication network 220, for example, via wired or wireless interfaces. These servers 230 may be configured to provide various types of services to the mobile device 215. For example, one or more servers 230 may execute one or more location based service (LBS) applications 240, which interoperate with software executing on the mobile device 215, to provide LBS's to a user. LBS's can use knowledge of a device's location and calculated transport times, to provide location-specific information, recommendations, notifications, interactive capabilities, and/or other functionality to a user. For example, an LBS application 240 can provide location and transport mode data to a network-based publication system 120, which can then be used to assist in generating offers relevant to the user's current location and transport mode. Knowledge of the device's location, and transport mode, may be obtained through interoperation of the mobile device 215 with a location determination application 250 executing on one or more of the servers 230.

Location information may also be provided by the mobile device 215, without use of a location determination application, such as application 250. In certain examples, the mobile device 215 may have some limited location determination capabilities that are augmented by the location determination application 250.

In some examples, the one or more servers 230 can also include a publication application 260 for providing location-aware offers that may be triggered by a user's presence inside a geofence. In certain examples, location data can be provided to the publication application 260 by the location determination application 250. In some examples, the location data provided by the location determination application 250 can include merchant information (e.g., identification of a retail location). In certain examples, the location determination application 250 can receive signals via the network 220 to further identify a location. For example, a merchant may broadcast a specific IEEE 802.11 service set identifier (SSID) that can be interpreted by the location determination application 250 to identify a particular retail location. In another example, the merchant may broadcast an identification signal via radio-frequency identification (RFID), near-field communication (NFC), or similar protocol that can be used by the location determination application 250. In response to a determination that a user is inside the geofence, a publication may be provided to the user containing an advertisement for a second nearby retail location.

Transport mode information may be provided interactively by a user, or by configuring a certain transport mode. In certain examples, transport mode information may be determined by a transport application 270 based on a user's prior movements. For example, if the mobile device 215 rarely or never exceeds a speed of six miles per hour, the transport application 270 may determine that the user only has walking as an available transport mode. If the mobile device 215 rarely or never exceeds a speed of twenty miles per hour, but periodically reaches speeds between ten and twenty miles per hour in one or more locations that correspond to a bicycle path, the transport application 270 may determine that the user has walking or bicycling as an available transport mode. If the mobile device 215 regularly or periodically exceeds speeds of thirty miles per hour in locations that correspond to roads or highways the transport application 270 may determine that the user has walking as an available transport mode, but more frequently travels by automobile. If the mobile device 215 regularly or periodically travels in locations that correspond to public transportation routes (e.g., bus lines, subway routes, etc.) the transport application 270 may determine that the user has walking and public transportation as available transport modes. These example transport modes and speeds are provided by way of example, and not by way of limitation. The transport application 270 may determine that any combination of multiple transport modes are available based on these examples or other analysis of the movements of mobile device 215. Application determinations of available user transport modes may be based on any one or combination of user selections or environmental (e.g., speed, location) inputs to the mobile device 215. In certain examples, the transport application 270 may be incorporated into the mobile device 215.

A traffic server 280 may be accessed by one or more of the servers 230 to obtain real-time or historical traffic information that may be related to a route, a user or a geographic area. For example, a regional transit authority or a traffic data aggregator (e.g., Traffic by MapQuest of Denver, Colo.) may provide traffic data for various locations via the traffic server 280. The transport application 270 may obtain the traffic data from traffic server 280 via the network 220. The traffic data may be utilized to compute an expected travel time along a route between two locations, such as between a user's location and a retail location.

In some examples, the one or more servers 230 can also include or access one or more data stores 290. The one or more data stores 290 may include information related to merchants (e.g., advertisers), user profiles, location histories, or other data. For example, publication application 260 may access a merchant data store 292 that may include content for an advertisement or location data for one or more retail locations. In another example, the location based service application 240 or the transport application 270 may access one or more user profiles 294 in order to determine what mode or modes of transport are available to an individual user. The location determination application 250 may access or write location data to a location history data store 296.

### Example Mobile Device

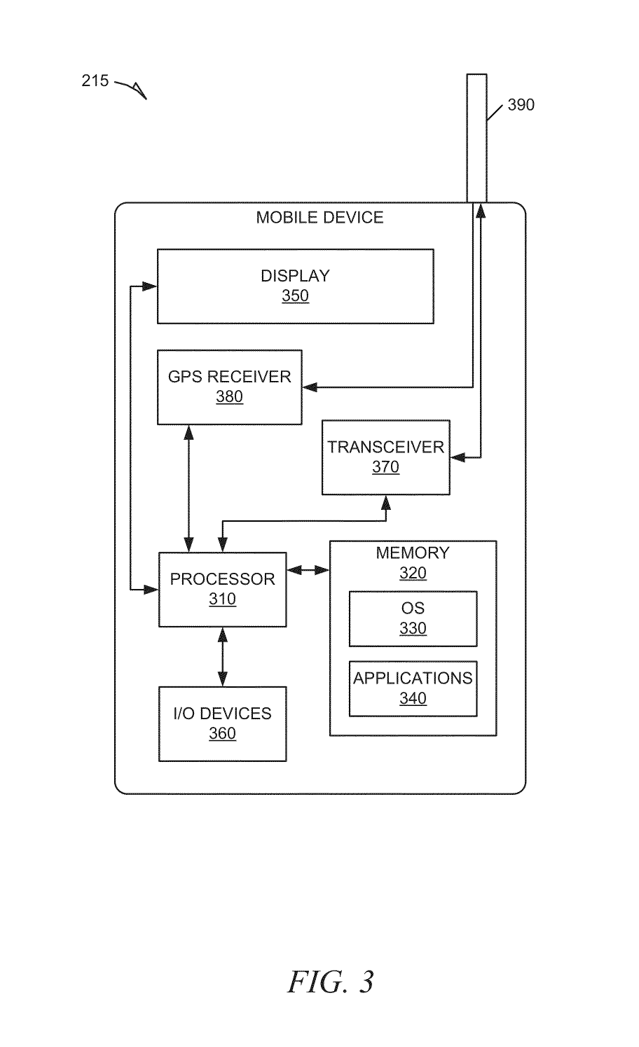

FIG. 3 is a block diagram illustrating the mobile device 215, according to an example embodiment. The mobile device 215 may include a processor 310. The processor 310 may be any of a variety of different types of commercially available processors suitable for mobile devices, for example, an XScale architecture microprocessor, a Microprocessor without Interlocked Pipeline Stages (MIPS) architecture processor, or another type of processor. A memory 320, such as a Random Access Memory (RAM), a Flash memory, or other type of memory, is typically accessible to the processor 310. The memory 320 may be adapted to store an operating system (OS) 330, as well as application programs 340, such as a mobile location enabled application that may provide LBS's to a user. The processor 310 may be coupled, either directly or via appropriate intermediary hardware, to a display 350 and to one or more input/output (I/O) devices 360, such as a keypad, a touch panel sensor, a microphone, etc. Similarly, in some embodiments, the processor 310 may be coupled to a transceiver 370 that interfaces with an antenna 390. The transceiver 370 may be configured to both transmit and receive cellular network signals, wireless data signals, or other types of signals via the antenna 390, depending on the nature of the mobile device 215. In this manner the connection 310 with the communication network 220 may be established. Further, in some configurations, a GPS receiver 380 may also make use of the antenna 390 to receive GPS signals. The processor 310 and transceiver 370 may be configured to transmit device data such as an internet protocol (IP) address or GPS coordinates obtained from a GPS receiver 380.

### Example Platform Architecture

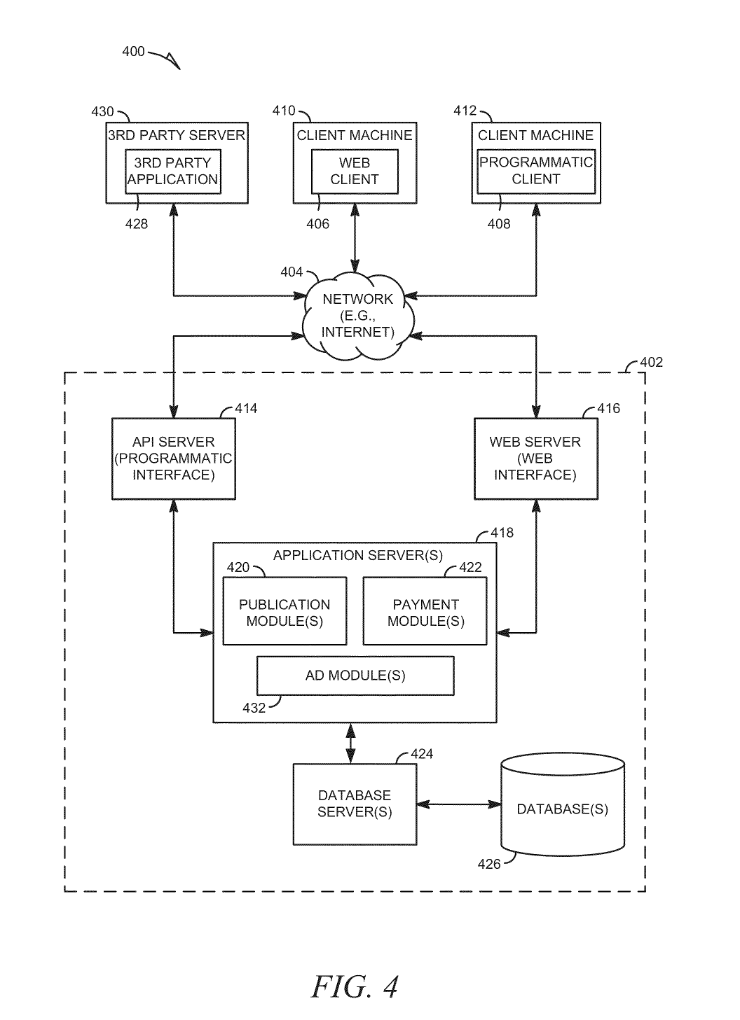

FIG. 4 is a block diagram illustrating a network-based system 400 for generating, delivering, and updating transport aware advertisements, according to an example embodiment. A networked system 402, in the example forms a network-based location-aware publication, advertisement, or marketplace system, that provides server-side functionality, via a network 404 (e.g., the Internet or a Wide Area Network (WAN)) to one or more client machines 410, 412. FIG. 4 illustrates, for example, a web client 406 (e.g., a browser, such as the Internet Explorer browser developed by Microsoft Corporation of Redmond, Wash.), and a programmatic client 408 (e.g., WHERE smart phone application from Where, Inc. of Boston, Mass.) executing on the respective client machines 410 and 412. In an example, the client machines 410 and 412 can be in the form of a mobile device, such as mobile device 215. In an example, the client machines 410 and 412 can be in the form of a personal computing device, such as a laptop or desktop computer.

An Application Programming Interface (API) server 414 and a web server 416 are coupled to, and provide programmatic and web interfaces respectively to, one or more application servers 418. The application servers 418 host one or more publication modules 420 (in certain examples these can also include commerce modules, advertising modules, and marketplace modules, to name a few), payment modules 422, and context sensitive ad modules 432. The application servers 418 are, in turn, shown to be coupled to one or more database servers 424 that facilitate access to one or more databases 426. In some examples, the application server 418 can access the databases 426 directly without the need for a database server 424.

The publication modules 420 may provide a number of publication functions and services to users that access the networked system 402. The payment modules 422 may likewise provide a number of payment services and functions to users. The payment modules 422 may allow users to accumulate value (e.g., in a commercial currency, such as the U.S. dollar, or a proprietary currency, such as “points”) in accounts, and then later to redeem the accumulated value for products (e.g., goods or services) that are advertised or made available via the various publication modules 420, within retail locations, or within external online retail venues. The payment modules 422 may also be configured to present or facilitate redemption of offers, included within advertisements generated by the ad modules 432, to a user during checkout (or prior to checkout, while the user is still actively shopping).

The ad modules 432 may provide real-time location-aware or transport-aware advertisements to users of the networked system 402. The ad modules 432 can be configured to use all of the various communication mechanisms provided by the networked system 402 to present advertisements to users. In an example, the ad modules 432 can provide context sensitive dynamic advertisements to the publication modules 420 for delivery. The advertisements can be dynamically personalized based on current location, time of day, user profile data, past purchase history, or recent physical or online behaviors recorded by the network-based system 400, among other things.

While the publication modules 420, payment modules 422, and ad modules 432 are shown in FIG. 4 to all form part of the networked system 402, it will be appreciated that, in alternative embodiments, the payment modules 422 may form part of a payment service that is separate and distinct from the networked system 402. Additionally, in some examples, the ad modules 432 may be part of the payment service or may form an advertisement generation service separate and distinct from the networked system 402. Further, while the system 400 shown in FIG. 4 depicts a client-server architecture, the present invention is of course not limited to such an architecture, and embodiments of the present invention could equally well find application in a distributed, or peer-to-peer, architecture system, for example. The various publication modules 420, payment modules 422, and ad modules 432 could also be implemented as standalone systems or software programs, which do not necessarily have networking capabilities.

The web client 406 accesses the various publication modules 420, payment modules 422, and ad modules 432 via the web interface supported by the web server 416. Similarly, the programmatic client 408 accesses the various services and functions provided by the publication modules 420, payment modules 422, and ad modules 432 via the programmatic interface provided by the API server 414. The programmatic client 408 may, for example, be a smart phone application (e.g., the WHERE application developed by Where, Inc., of Boston, Mass.) to enable users to receive context sensitive dynamic advertisements on their smart phones leveraging available context data, such as user profile data and current location information provided by the smart phone or accessed over the network 404.

FIG. 4 also illustrates a third party application 428, executing on a third party server machine 430, as having programmatic access to the networked system 402 via the programmatic interface provided by the API server 414. For example, the third party application 428 may, utilizing information retrieved from the networked system 402, support one or more features or functions on a website hosted by the third party. The third party website may, for example, provide one or more promotional, marketplace or payment functions that are supported by the relevant applications of the networked system 402. Additionally, the third party website may provide advertisers with access to the ad modules 432 for configuration purposes. In certain examples, advertisers can use programmatic interfaces provided by the API server 414 to develop and implement rules-based ad schemes (e.g., campaigns) that can be implemented via the publication modules 420, payment modules 422, and ad modules 432.

### Example Ad Modules

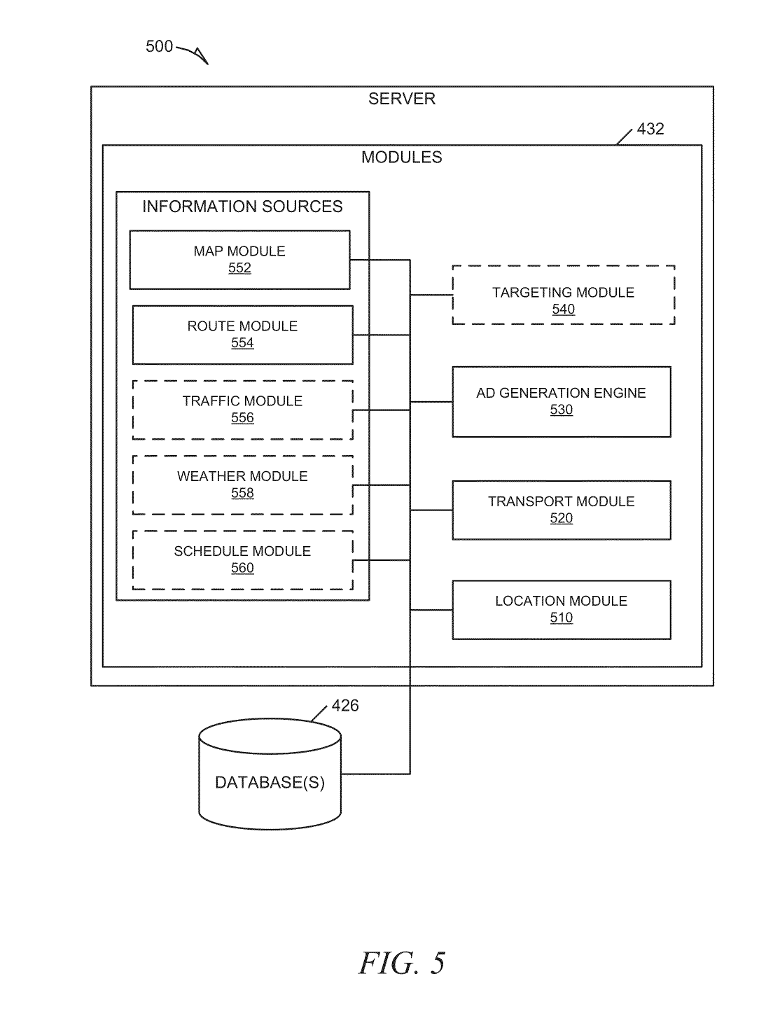

FIG. 5 is a block diagram illustrating server 500 that may be utilized in a transport aware system, according to an example embodiment. In this example, server 500 includes an ad module 432. The ad module 432 can include a location module 510, a transport module 520, an ad generation engine 530, and various information sources for transport information. Optionally, the ad modules 432 can also include a targeting module 540. Transport information sources can include a map module 552 and a route module 554, and optionally, a traffic module 556, a weather module 558, or a schedule module 560, to name just a few. In an example, the ad modules 432 can access database 426 to store and/or retrieve advertisement rules and campaign information, transport data, location data, as well as other information to enable transport sensitive advertisements to be generated, delivered, and updated.

In an example, the transport module 520 can gather and deliver context and transport data relevant to the ad generation engine 530 based on advertisement rules and campaign information provided by advertisers. The transport module 520 can interface with each of the various information sources to obtain and dynamically update advertisement content.

In an example, the targeting module 540 can use data from the various information sources to dynamically target advertisements to users based on the current context (e.g., location, time, events, weather, and the like). The targeting module 540 can interface with any of the other modules to determine if an individual should receive a targeted advertisement based on context, location, transport time, or other criteria.

In an example, the location module 510 is configured to receive location data from a device, such as mobile device 215, and to determine from the location data one or more participating merchant locations that are within a pre-defined proximity or target transport time. In some examples, the location module 510 can receive GPS-type coordinates (e.g., longitude and latitude), which can be used to establish a current location associated with a mobile device (and thus a user of the mobile device). Using the longitude and latitude coordinates, the location module 510 can determine if any merchants with physical locations registered with the networked system 402 are in proximity to the current location associated with the user. In certain examples, the location module 510 can receive other location determining information from a device, such as an internet protocol address that can be cross-referenced to a user's home, business, or other physical location.

For example, some merchants may broadcast specific wireless network signals that can be received by a mobile device, such as mobile device 215. Once received, the mobile device 215 can include programming or circuitry to translate the signal into a specific location, or the mobile device 215 can simply retransmit the unique signal to the location module 510. In an example, a merchant location can transmit a unique SSID, which the location module 510 can be programmed to interpret as identifying a specific merchant location. In another example, the merchant may broadcast a unique SSID within all of its locations, and the location module 510 can be programmed to use a combination of the unique SSID and other location data (e.g., GPS coordinates or cell tower locations) to identify a specific location.

In an example, some merchants may wish to target users that are within a certain geofence defined by the merchant. For example, the merchant may define the geofence as all users or devices that are at a location within a ten-minute drive by automobile to a point of interest defined by the merchant. The map module 552 can access various sources of mapping information over the network 404. The map module 552 can receive map information based on a location of the user provided by the location module 510.

In an example, some merchants may wish to target users that are within a certain geofence defined by a transport time to the merchant's location. The transport time may be a target transport time specified by the merchant. The route module 554 can receive a user's location information from the location module 510, and based on the location information and map information from the map module 552, with or without overlaid traffic information, provide routing information for one or more modes of transport. The transport module 520 may utilize the routing information, map information and location of the user to determine whether one or more users can travel to the merchant's location within the specified transport time.

In an example, the traffic module 556 can access various sources of traffic information over the network 404, and deliver traffic related data and alerts to the map module 552 that may be overlaid onto the map information. The traffic module 556 may also include, or be configured to access, speed limit information that may be combined with map data to calculate an expected transport mode speed along a route. In an example, a merchant may select an option to include or exclude traffic related data when defining a geofence around a point of interest.

In certain examples the route module 554 may receive weather information from a weather module 558. The weather information may be combined with route information or applied generally to a transport time calculation. For example, if the weather module 558 accesses weather information that indicates heavy precipitation along a route, the expected transport time along the route may be increased to reflect the real-world conditions. In an example, a merchant may select an option to include or exclude weather related data when defining a geofence around a point of interest.

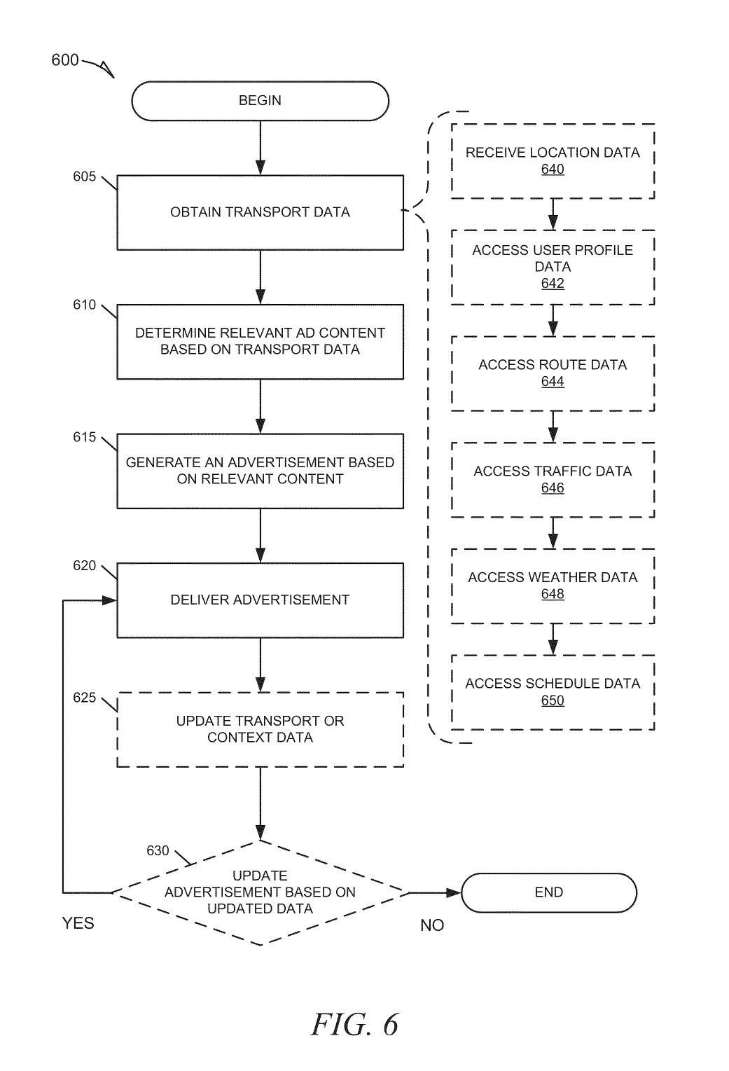

In certain examples the route module 554 may receive public transit schedule information from a schedule module 560. The route module 554 may determining the transport time to the point of interest is based at least in part on the first transportation mode such as walking, (e.g., to a bus stop or subway station) and a second transportation mode such as public transportation (e.g., bus or subway). The total transport time for both the first transportation mode and the second transportation mode may be less than that travel time defined by the geofence. In this manner multiple modes of transport may be considered when determining if an individual user is within a geofence. Additional details regarding the functionality provided by the location-aware offer modules 432 are detailed in reference to FIGS. 6-8. In an example, a merchant may select an option to include or exclude public transit, or any other combination of transport modes, as an available transportation mode when defining a geofence around a point of interest.

### Example Methods

FIG. 6 is a flowchart illustrating a method 600 for generating, delivering, and updating transport aware mobile advertisements, according to an example embodiment. In an example, the method 600 can include operations for obtaining transport data at 605, determining relevant ad content at 610, generating an advertisement at 615, delivering the advertisement at 620, optionally updating transport or context data at 625, and optionally determining at 630 whether to update the advertisement at 620. In this example, the method 600 can include the following operations to obtain real-time transport data at 605, receiving location data at 640, accessing user profile data at 642, accessing route data at 644, accessing traffic data at 646, accessing weather data at 648, and accessing schedule data at 650. The illustrated examples of transport data (640-650) are merely exemplary and should not be considered limiting.

In an example, the method 600 can being at 605 with the ad generation engine 530 obtaining real-time transport data. In another example, the transport module 520 can obtain the real-time transport data from the various transport information sources (e.g., modules 552-560). At 610, the method 600 can continue with the ad generation engine 530 determining relevant ad content based on the transport data. In certain examples, the ad generation engine 530 can provide the relevant content.

At 615, the method 600 can continue with the ad generation engine 530 generating a dynamic advertisement based on the relevant content. At 620, the method 600 can continue with the publication module 420 delivering the advertisement generated by the ad generation engine 530. At 625, the method 600 can continue with the ad modules 432 updating context data. In certain examples, the ad modules 432 can periodically check for updated location or context data (e.g., once every thirty seconds). In other examples, real-time context data feeds, such as context data accessed in operations 640 through 650, can be configured to push updates and trigger operation 625. At 630, the method 600 continues with the ad modules 432 determining whether to update the advertisement based on the updated transport or context data. If the advertisement is updated, the method 600 continues by looping back to 620 with the publication module 420 delivering an updated version of the advertisement. In some examples, the updated content can be pushed out automatically to the advertisement. If the dynamic content stops updating the method 600 can end. In certain examples, the method 600 can continue looping to continue checking for updated data, among other things.

Though arranged serially in the example of FIG. 6, other examples may reorder the operations, omit one or more operations, and/or execute two or more operations in parallel using multiple processors or a single processor organized as two or more virtual machines or sub-processors. Moreover, still other examples can implement the operations as one or more specific interconnected hardware or integrated circuit modules with related control and data signals communicated between and through the modules. Thus, any process flow is applicable to software, firmware, hardware, and hybrid implementations.

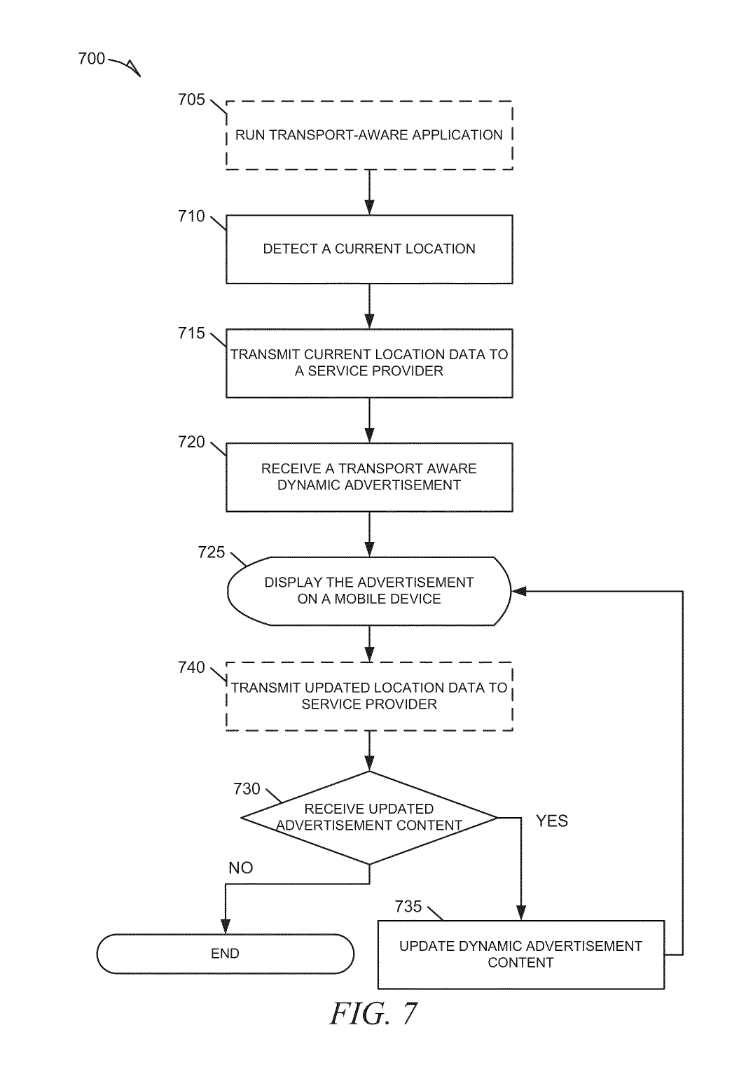

FIG. 7 is a flowchart illustrating a method 700 for receiving transport aware advertisements, according to an example embodiment. In an example, the method 700 can include operations for detecting a current location at 710, transmitting the current location data to a service provider at 715, receiving a context sensitive dynamic advertisement at 720, displaying the advertisement at 725, determining if updated advertisement content is received at 730, and updating the dynamic advertisement content at 735. Optionally, the method 700 can also include operations for running a transport-aware application at 705, and transmitting updated location data to a service provider at 740. The operations outlined in method 700 can all occur within a device, such as device 115 or mobile device 215.

The method 700 can begin at 710 with the mobile device 215 detecting a current location. At 715, the method 700 can continue with the mobile device 215 transmitting the current location data to a service provider. At 720 the mobile device 215 receives a transport aware dynamic advertisement in response to transmitting the current location data. In an example, the transport aware dynamic advertisement can be received from a networked system, such as networked system 402. Optionally, at 720 the mobile device 215 may receive the routing data indicating a transportation route from the current location to a point of interest, in addition to transport aware dynamic advertisement in response to transmitting the current location data.

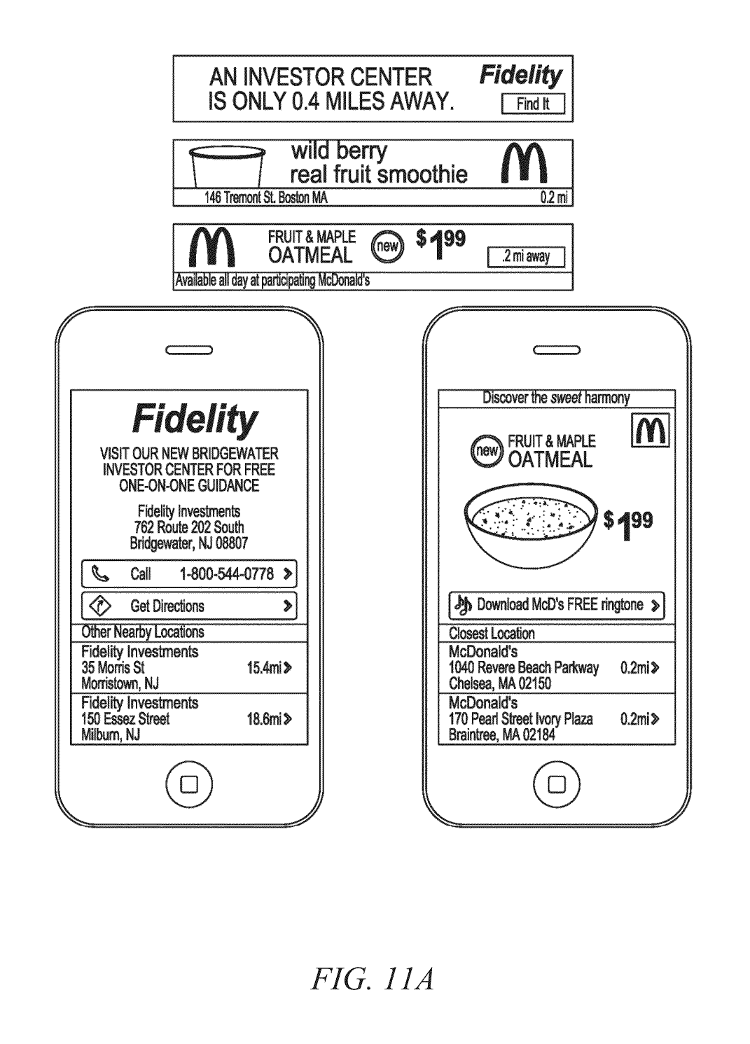

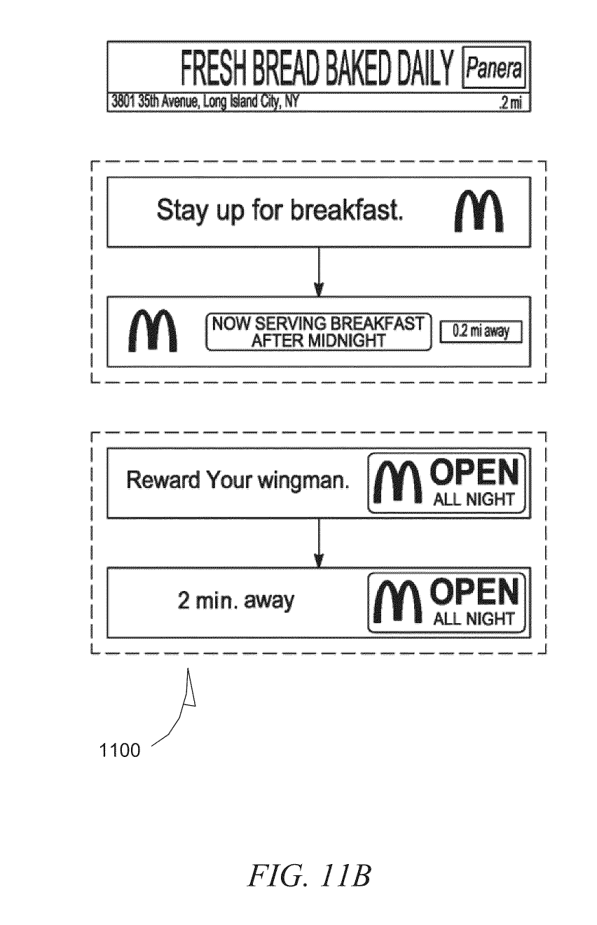

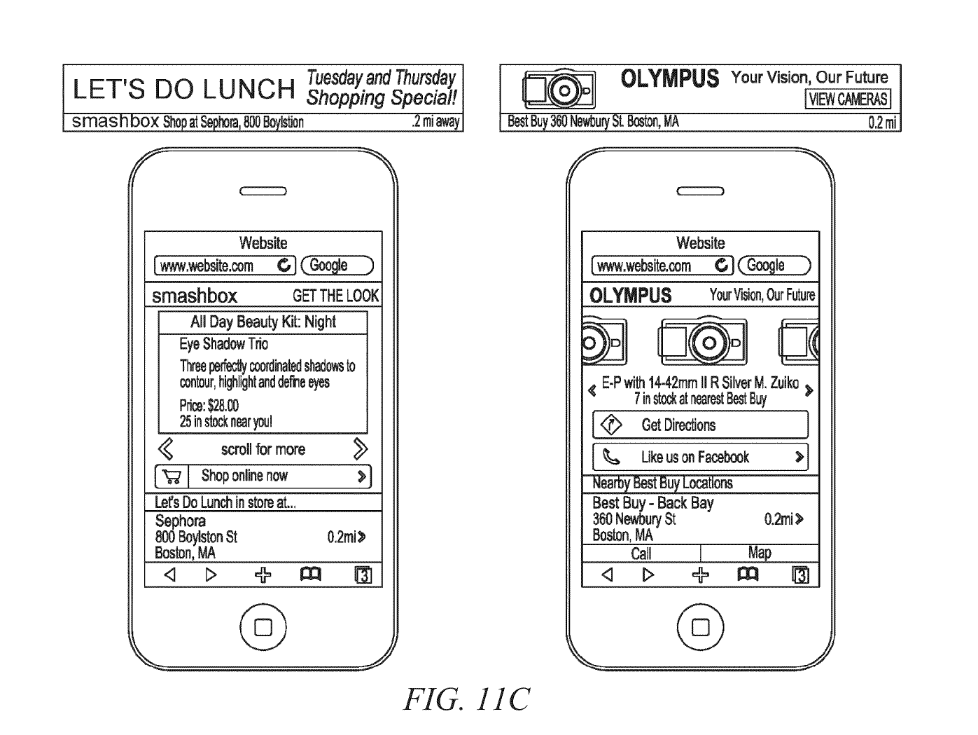

At 725, the method 700 can continue with the mobile device 215 displaying the advertisement. In an example, the transport aware dynamic advertisement can be displayed as a banner ad within a mobile application. For additional examples of dynamic advertisements, see FIGS. 11A through 11C.

At 740, the method 700 can optionally include the mobile device 215 transmitting updated location data (or user-related context data) to a service provider (e.g., networked system 402). At 730, the method 700 can continue with the mobile device 215 checking for receipt of updated advertisement content. If new advertisement content is received at 730, the method 700 can continue at 735 with the mobile device 215 updating the dynamic advertisement with the updated content. In some examples, the entire advertisement is updated (e.g., replaced). For example, the update may indicate that the offer presented in a first dynamic advertisement has expired, and the first advertisement is replaced with second advertisement that as not expired. The second advertisement may or may not also be a transport aware dynamic advertisement. In other examples, the mobile device 215 can merely update the dynamic portion of the advertisement. For example, the dynamic portion of the advertisement may indicate the distance between the user's location and a retail location indicated in the advertisement. In yet other examples, the networked system 402 can push updated content directly to the dynamic advertisement.

Optionally, the method 700 can begin at 705 with the mobile device 215 running a transport-aware application. In an example, the service provider can operate the networked system 402.

Though arranged serially in the example of FIG. 7, other examples may reorder the operations, omit one or more operations, and/or execute two or more operations in parallel using multiple processors or a single processor organized as two or more virtual machines or sub-processors. Moreover, still other examples can implement the operations as one or more specific interconnected hardware or integrated circuit modules with related control and data signals communicated between and through the modules. Thus, any process flow is applicable to software, firmware, hardware, and hybrid implementations.

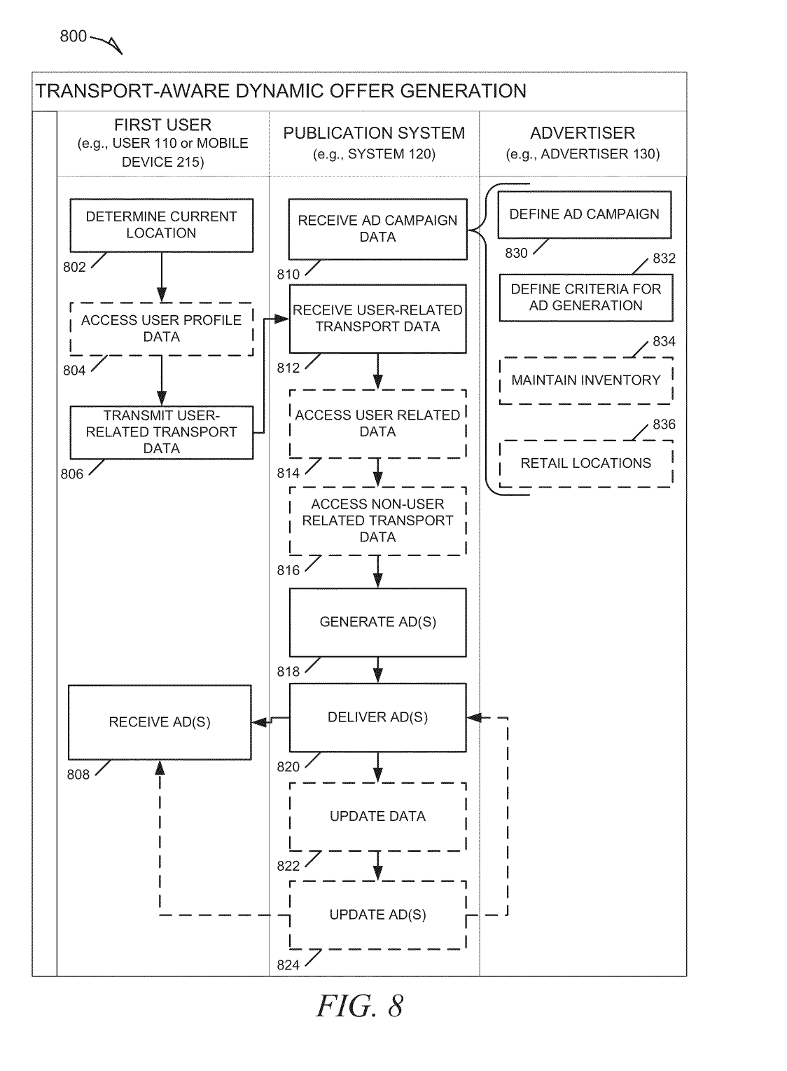

FIG. 8 is a swim-lane chart illustrating a method 800 for generating, delivering, and updating context sensitive dynamic offers (e.g., advertisements), according to an example embodiment. The method 800 illustrates example interactions between a user (e.g., mobile device 215), a networked system 402 (e.g., network-based publication system 120), and an advertiser (e.g., advertiser 130) in generating, delivering, and optionally updating transport-aware advertisements, according to an example embodiment.

At 802, the method 800 can begin with the mobile device 215 determining a current location associated with the mobile device 215. At 804, the method 800 can optionally continue with the mobile device 215 accessing user profile data. The user profile data can provide user-related context data, such as transport modes available to the user, that can be added to the current location data. At 806, the method 800 continues with the mobile device 215 transmitting user-related context data to a publication system, such as system 120.

In reference to system 100, the method 800 can begin at 810 with the system 120 receiving ad campaign data from an advertiser, such as advertiser 130. At 812, the method 800 can continue with the system 120 receiving the user-related transport data, such as a GPS location generated by the mobile device 215 or other location identifying data. At 814, the method 800 can optionally continue with the system 120 accessing user-related data, such as pre-registered transport modes or user preferences. At 816, the method 800 can optionally continue with the system 120 accessing non-user related transport data, such as the transport data discussed above in reference to FIGS. 5 and 6 or Table 1. In certain examples, the non-user transport data is obtained from information source modules 552-560.

At 818, the method 800 can continue with the system 120 generating one or more advertisements. At 820, the method 800 can continue with the system 120 delivering advertisements, such as to mobile device 215. At 808, the method 800 can include the mobile device 215 receiving the advertisements generated and transmitted by system 120. At 822, the method 800 can optionally continue with the system 120 updating context data (e.g., user-related and non-user related context data). At 824, the method 800 can optionally continue with the system 120 updating the advertisements based on updated context data.

In reference to advertiser 130, at 830 the method 800 can include the advertiser defining an advertising campaign to be implemented on system 120. At 832, the method 800 can include the advertiser 130 defining criteria for ad generation. In an example, the defining criteria for ad generation may be for an ad to be delivered to a set of users that are within a geofence defined by the time needed for the users to travel, by any mode or a specific mode of transport, to a retail location associated with the advertiser 130. At 834, the method 800 can optionally include the advertiser 130 maintaining inventory information. In an example, the inventory information can be used by system 120 to dynamically update advertisements containing inventory information, or to assist in determining the size of the geofence based on a relationship between the inventor and the number of users in the geofence. At 836, the method 800 can optionally include the advertiser 130 maintaining or updating a list of retail locations.

### Example Geofences

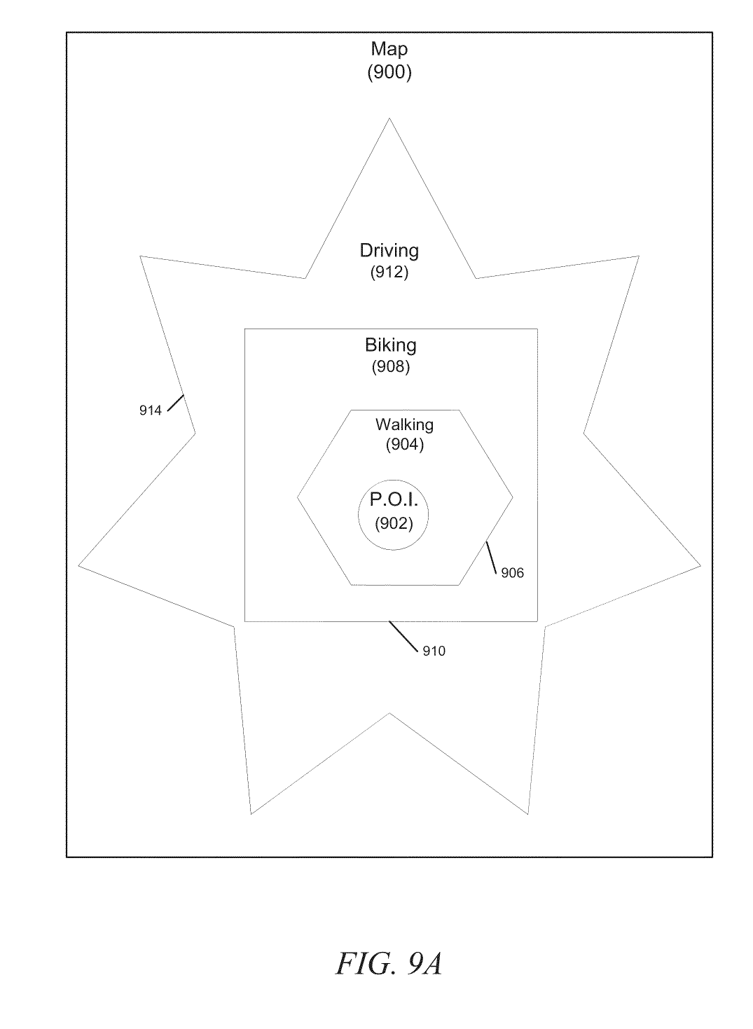

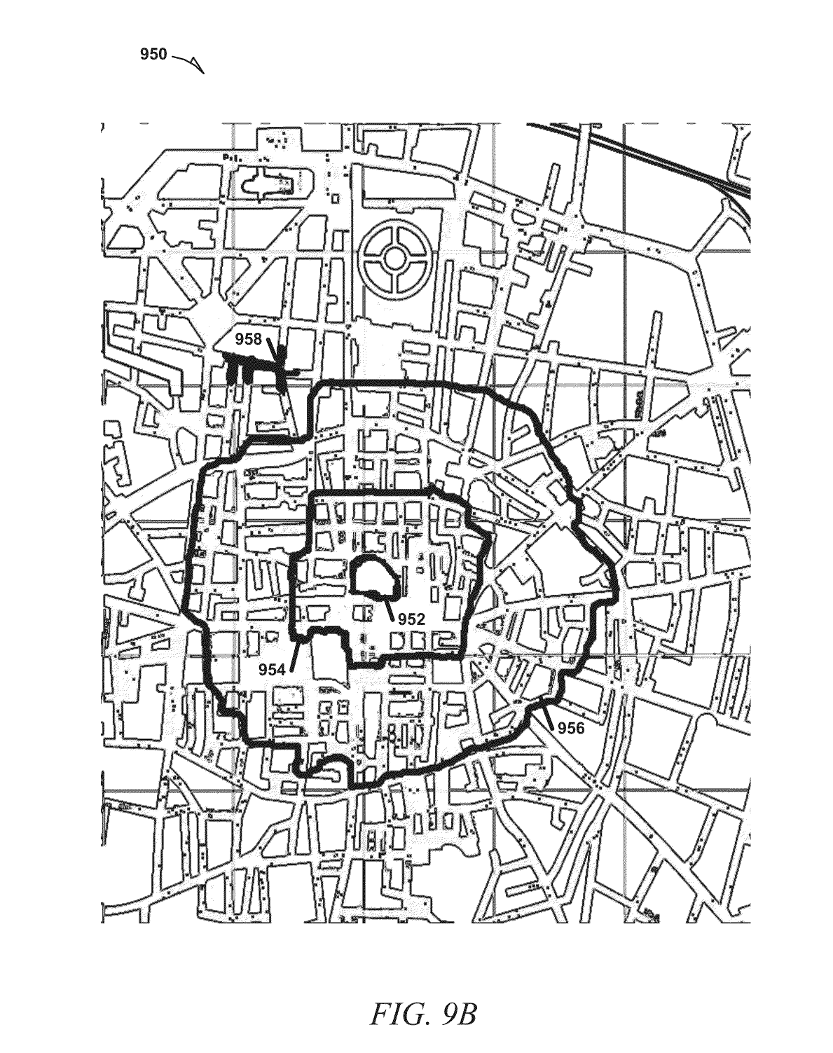

FIG. 9A is an example map 900 illustrating a point of interest 902, and various geofences around the point of interest 902. In an example, the point of interest 902 may be a retail location of an advertiser. The geofences are based on a travel time to the point of interest 902 using various modes of transportation. For example, an advertiser located at the point of interest 902 may wish to define a geofence that includes individuals who are able to travel to the point of interest 902 within a limited period of time. The limited period of time may be arbitrarily chosen by the advertiser. In this example fifteen minutes will be used, although other time periods ranging from a few minutes to several hours are contemplated.

A walking geofence 904 defines a boundary 906 on the map 900 that includes locations from which a user may walk to the point of interest 902 with the limited period of time. A biking geofence 908 defines a boundary 910 on the map 900 that includes locations from which a user may bicycle to the point of interest 902 within the limited period of time. A driving geofence 912 defines a boundary 914 on the map 900 that includes locations from which a user may drive to the point of interest 902 within the limited period of time. As depicted on the map 900, geofences for various modes of transportation need not be concentric or aligned.

Each geofence for a specific mode of transportation may conform to natural or man-made geographic features that may impact an amount of time a user may need to travel from a location within the geofence to the point of interest 902. For example, traffic on one or more individual roads may bias the shape of the driving geofence 912 away from traffic congestion. The boundary 914 may be dynamically updated in response to changing traffic conditions. The boundary 910 of biking geofence 908 may reflect travel time that may be facilitated by bicycle specific trails, paths or lanes. Specific bicycle paths or lanes may allow a biking geofence 908 to exceed the area of the boundary 914, for example if the point of interest 902 is located in an urban area with high traffic density and multiple dedicated bicycle paths. The boundary 906 of the walking geofence 904 may reflect pedestrian specific walkways, sidewalks, trails or publicly accessible routes through or around buildings or other potential pedestrian obstacles.

FIG. 9B is an example map 950 illustrating a point of interest 952, and various geofences around the point of interest 952. The map 950 generically depicts an urban geography with various intersecting driving and paths between buildings, parks, and other real-world landmarks. The point of interest 952 is depicted as a building located approximately in the center of the map 950; however, the point of interest 952 may be defined as any physical location on map 950. For example, an advertiser (e.g., advertiser 130) may wish to define a walking geofence 954 by a ten-minute walking time to a retail location located at the point of interest 952. Similarly, the advertiser may also wish to define a driving geofence 956 by a fifteen-minute drive-time to the retail location located at the point of interest 952. In an example, a location of traffic congestion 958 may impact the shape or area of the driving geofence 956, by decreasing the area of the driving geofence 956 in response to an additional amount of time beyond the fifteen-minute criteria defining the driving geofence 956.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

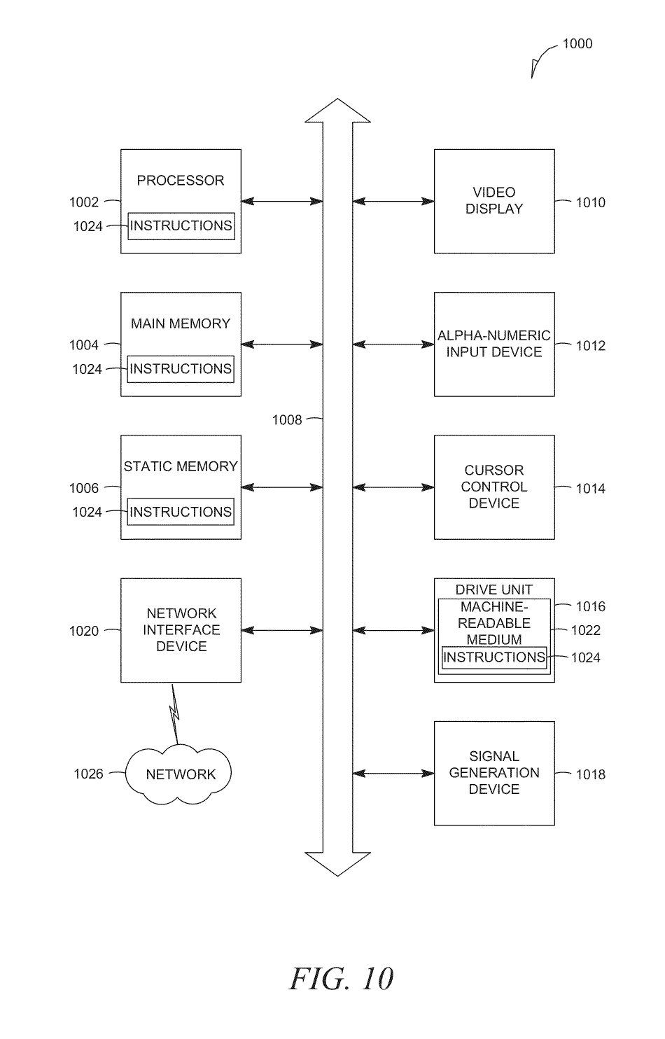

FIG. 10 is a block diagram of machine in the example form of a computer system 1000 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

### Machine-Readable Medium

The disk drive unit 1016 includes a machine-readable medium 1022 on which is stored one or more sets of instructions and data structures (e.g., software) 1024 embodying or used by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media. The instructions 1024 may also reside within static memory 1006.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi and Wi-Max networks). The term “transmission medium” shall be taken to include any intangible medium that is capable of storing, encoding or carrying instructions for execution by the machine, and includes digital or analog communications signals or other intangible media to facilitate communication of such software.

### EXAMPLE ADVERTISEMENTS

FIG. 11A-11C are diagrams illustrating example transport aware dynamic mobile advertisements, according to various example embodiments.

FIG. 11A illustrates an example context sensitive dynamic mobile advertisement using dynamically updating location within a banner advertisement. In an example, physical location addresses and/or proximity can be automatically populated based on user (e.g., device 115) location. The networked system 402 can track metrics on the dynamic advertisements, including click-throughs and call length (if a call is initiated based on the advertisement).

FIG. 11B illustrates an example transport aware dynamic mobile advertisement using animated banner advertisements. Animated banner advertisements can include rotating graphics, rotating text, and fade transitions, among other things. Animated banner advertisements can also integrate other dynamically changing content, such as location. The port aware dynamic mobile advertisement may include an expected transport time 1100 from the user's current location to the nearest retail location associated with the advertisement. The expected transport time 1100 may be equal to or less than a transport time geofence specified by the advertiser.

FIG. 11C illustrates an example context sensitive dynamic mobile advertisement displaying real-time inventory information. Any of the features or aspects of the illustrated example advertisements may be combined into a single advertisement.

Thus, a method and system for delivering transport aware publications to users in a network-based environment have been described. Although the present inventive subject matter has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The claimed invention includes:

1. A method comprising:
receiving, on a publication system using one or more processors, ad campaign data, the ad campaign data including a point of interest (POI), a target transport time, and a plurality of target transportation modes;
generating, using the one or more processors, a plurality of geofences around the POI, each geofence of the plurality of geofences representing one of the plurality of target transportation modes and sized based on the target transport time; and
delivering, using the one or more processors, advertisements based on the ad campaign data to a mobile device in response to the mobile device being within one of the plurality of geofences.

2. The method of claim 1, further comprising:
receiving information regarding a transportation mode or a location from the mobile device.

3. The method of claim 1, wherein the generating the plurality of geofences includes receiving traffic data, the traffic data affecting the size of at least one of the plurality of geofences.

4. The method of claim 1, wherein the generating the plurality of geofences includes generating a geofence for two or more of the following transportation modes: walking, bicycle, automobile, public transportation, taxi, boat, train, and airplane.

5. A publication method comprising:
receiving, from a device over a network, device data indicating a location of the device;
calculating, on a publication system coupled to the network using one or more processors, a transport time from the location of the device to a location of a point of interest (POI) based at least in part on the device data and the location of the point of interest;
generating a publication, based at least in part on the transport time, the publication including a content portion related at least in part to the point of interest; and
transmitting the publication over the network to the device.

6. The method of claim 5, further comprising:
calculating routing data in response to receiving the device data;
wherein determining the transport time is based at least in part on the routing data.

7. The method of claim 6, further comprising:
accessing traffic data based on the location of the device;
wherein calculating routing data is based at least in part on the traffic data.

8. The method of claim 5, wherein determining the transport time to the point of interest is based at least in part on a first transportation mode.

9. The method of claim 5, further comprising:
determining, using the one or more processors, that the device is within one of a plurality of geofences around the POI, each geofence of the plurality of geofences representing one of the plurality of target transportation modes and sized based on a target transport time.

10. The method of claim 5, further comprising:
receiving ad data from an advertiser over a network, the ad data indicating the point of interest as a location of the advertiser and a target travel time;
wherein the content portion includes at least a portion of the ad data, and the publication is generated in response to the transport time being less than the target travel time.

11. A transport-aware publication system comprising:
a server including one or more processors, the one or more processors configured to execute modules, and transmit, over a network connection to a device, a publication, the modules including:
an advertiser module configured to receive a location for a point of interest and a target travel time;
a location module configured to receive, from a device over the network connection, device data;
a routing module configured to determine a transport time from the device to the location of the point of interest based at least in part on the device data and the location of the point of interest; and
an advertisement generation module configured to generate, based at least in part on the device data, the publication including a content portion to display data related to the point of interest when the transport time is within the target travel time, and to transmit the publication to the device over the network connection.

12. The system of claim 11, wherein the determination of the transport time is based at least in part on a certain mode of transportation received from the device over the network connection.

13. The system of claim 12, wherein the routing module is configured to access a traffic server and retrieve traffic data associated with a route between the device and the point of interest based on the device data, the location for the point of interest, and the certain mode of transportation.

14. The system of claim 12, comprising:
a user profile module configured to determine the certain mode of transportation based on at least one sensed rate of travel received from the device.

15. The system of claim 11, wherein the device data represents a current location of the device.

16. The system of claim 13, further comprising a targeting module configured to target a group of users based on the route;
wherein the device is associated with a user in the group of users.

17. The system of claim 13, further comprising a traffic module configured to receive traffic data based on the location of the device;
wherein the routing module is further configured to determine a transport time based at least in part on the traffic data.

18. A machine-readable storage medium including instructions that, when executed by a machine, cause the machine to:
receive, from a device over a network connection, device data indicating a location of the device;
determine a transport time from the location of the device to a location of a point of interest based at least in part on the device data and the location of the point of interest;
generate a publication, based at least in part on the transport time, the publication including a content portion related at least in part to the point of interest; and
transmit the publication over the network connection to the device.

19. The machine-readable storage medium of claim 18, wherein the instructions cause the machine to calculate routing data in response to receiving the device data;
and wherein determining the transport time is based at least in part on the routing data.

20. The machine-readable storage medium of claim 19, wherein the instructions cause the machine to access traffic data based on the location of the device; and
wherein calculating routing data is based at least in part on the traffic data.

21. The machine-readable storage medium of claim 19, wherein the instructions that cause the machine to transmit the routing data over the network connection to the device.

22. The machine-readable storage medium of claim 18, wherein determining the transport time to the point of interest is based at least in part on a first transportation mode and a second transportation mode.

23. A method comprising:
transmitting location data, from a device over a network, the location data indicating a current location of the device; and
receiving, in response to transmitting the location data, a publication over the network at the device, the publication being based at least in part on a calculated transport time from the current location of the device to a point of interest, the publication including a content portion related at least in part to the point of interest.

24. The method of claim 23, further comprising:
sensing at least one rate of travel obtained at the device; and
determining at least one available mode of transport based on at least one sensed rate of travel obtained at the device;
wherein the at least one available mode of transport is utilized to determine the calculated transport time.

25. The method of claim 24, further comprising:
transmitting the at least one available mode of transport from the device over the network.

26. The method of claim 25, further comprising:
calculating a route between the point of interest and the current location of the device; and
retrieving speed limit data indicating a maximum speed on the route for the at least one available mode of transport;
wherein determining the transport time from the location of the device to the location of the advertiser is based on the speed limit data.
